(19) United States
(12) Patent Application Publication
(10) Pub. No.: US 2026/0011967 A1
(43) Pub. Date: Jan. 8, 2026

(54) CRIMPING TOOL WITH STORAGE AND REPLACEMENT CLAMPING PARTS

(71) Applicant: Yu-Hsin Li, Changhua County (TW)

(72) Inventor: Yu-Hsin Li, Changhua County (TW)

(21) Appl. No.: 18/765,345

(22) Filed: Jul. 8, 2024

(51) Int. Cl. H01R 43/042

(52) U.S. Cl. CPC H01R 43/042

(57) ABSTRACT

A crimping tool includes a tool body including a clamping section and a handle section which is pivotably connected to the clamping section at a pivot section. The handle section has multiple accommodating slots, and each accommodating slot of the handle section has a corresponding slot opening. At least one positioning unit is located in each accommodating slot and includes a block. One of two ends of the block that faces an inner bottom of the accommodating slot has a positioning assembly. Multiple replacement clamping parts are movably located within each accommodating slot and respectively engaged with each block of the limiting assemblies. When the replacement clamping parts are removed from the accommodating slots, each replacement clamping part is assembled to the clamping section. This allows crimping operations for terminals of different specifications and sizes, making the process both convenient and time-saving.

### FIELD OF THE INVENTION

The present invention relates to a hand tool, and more particularly, to a crimping tool with storage in each handle and replacement clamping parts stored in the storage.

### BACKGROUND OF THE INVENTION

A conventional crimping tool is used to drive crimp terminals. The crimping tool is primarily used to connect terminals and wires. Different specifications of crimping tools are used depending on the type of terminal. Before crimping, it is crucial to confirm the terminal specifications and voltage and current. After stripping the insulation, the terminal is matched to the appropriate aperture on the crimping tool. The correct aperture ensures proper crimping of the terminal. The aperture size must be precise to avoid terminal deformation or jamming.

Based on the above, commonly used crimping tools have limited aperture sizes and cannot accommodate all terminal specifications. Therefore, the crimping tools sold and used in the market today often come with interchangeable dies (dies refer to replaceable crimping parts that have structures designed to crimp terminals). Each die has apertures that match different terminals. However, users often need to carry all the dies with them to match different terminals, which is inconvenient and easy to lose. Hence, related industries need to reconsider how to achieve crimping that fits different terminal specifications while ensuring that the dies are easy to carry and less likely to be lost.

The present invention intends to provide a crimping tool with storage in each handle and replacement clamping parts stored in the storage to eliminate the shortcomings mentioned above.

### SUMMARY OF THE INVENTION

The present invention relates to a crimping tool comprises a tool body including a clamping section and a handle section which is pivotably connected to the clamping section at a pivot section. The handle section has multiple accommodating slots, and each accommodating slot of the handle section has a corresponding slot opening. At least one positioning unit is located in each accommodating slot and includes a block. One of two ends of the block that faces an inner bottom of the accommodating slot has a positioning assembly. Multiple replacement clamping parts are movably located within each accommodating slot and respectively engaged with each block of the limiting assemblies.

The primary object of the present invention is to provide users with a crimping tool that allows for the convenient and quick replacement of corresponding dies for crimp terminals of different specifications and sizes. The dies can be carried together with the crimping tool, eliminating the need for separate handling and carrying. This prevents issues of loss and improves the user experience compared to traditional methods, where the dies had to be carried separately, causing inconvenience for the user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the first embodiment of the present invention;

FIG. 2 is an exploded view of the first embodiment of the present invention;

FIG. 3 illustrates the action of removing and replacing the clamping parts in the first embodiment of the present invention;

FIG. 4 is a cross sectional view, taken along line IV-IV in FIG. 2, and

FIG. 5 illustrates the action of removing and replacing the clamping parts in FIG. 4.

### DETAILED DESCRIPTION OF THE PREFERRED EMBODIMENT

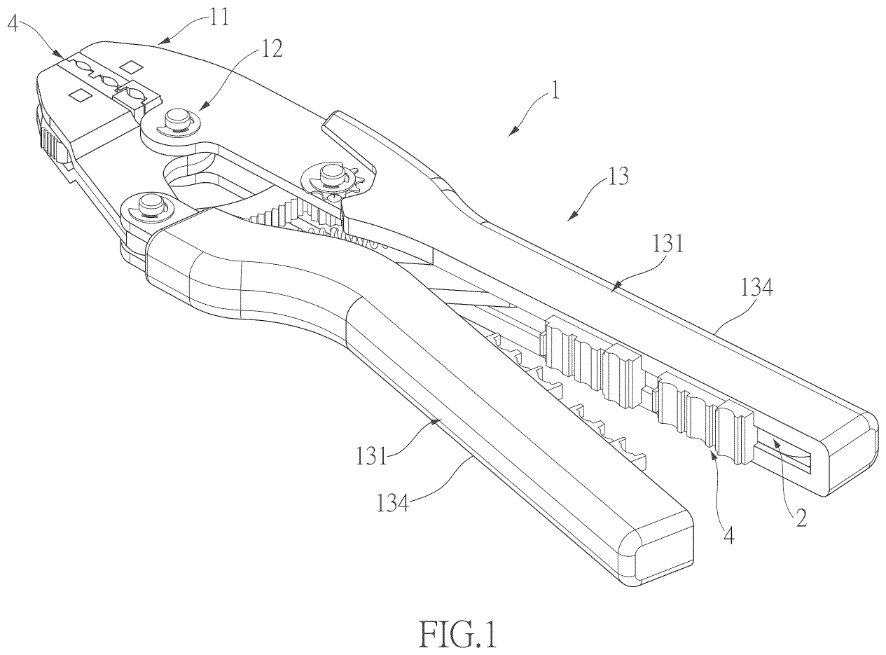

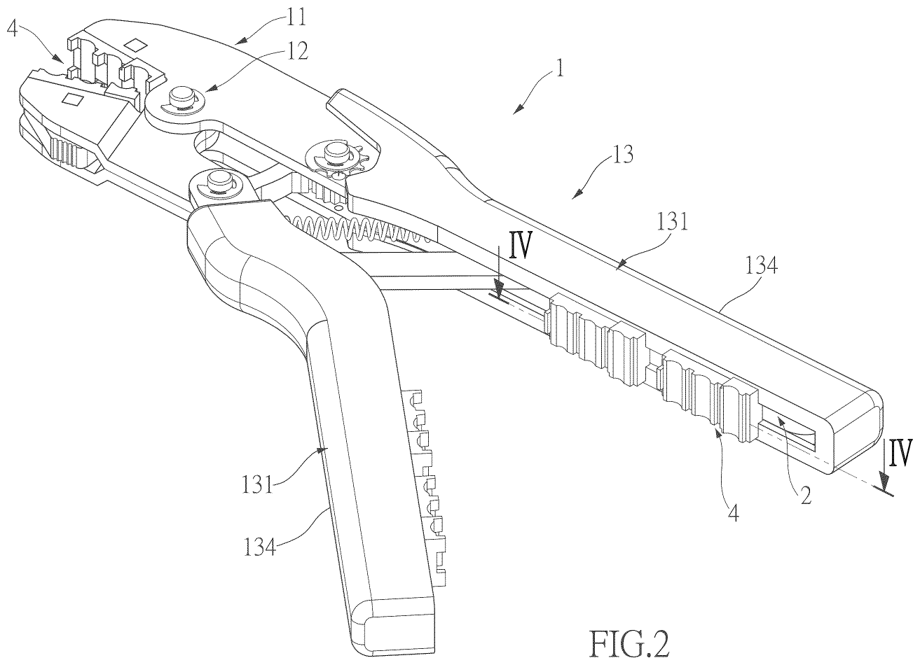

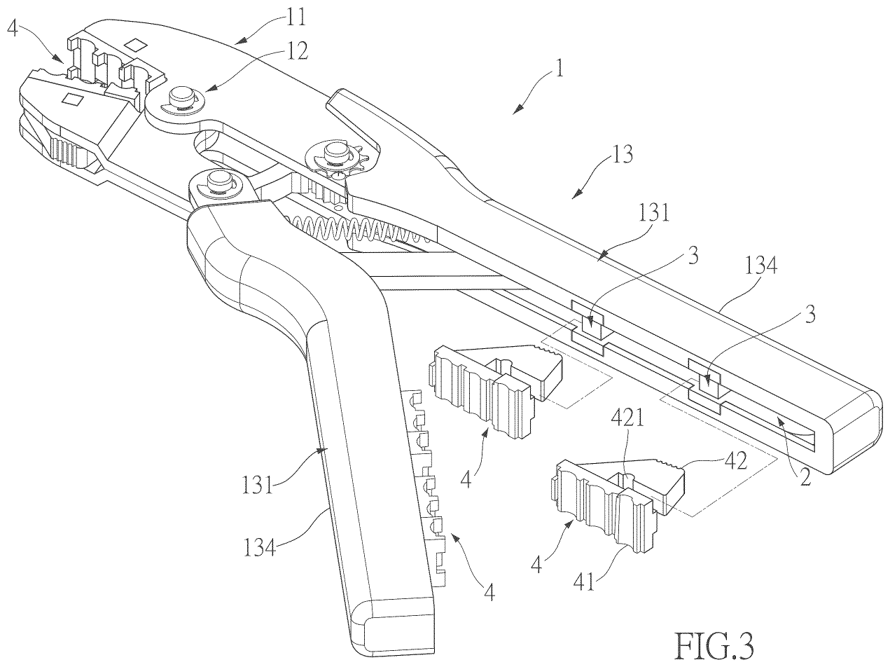

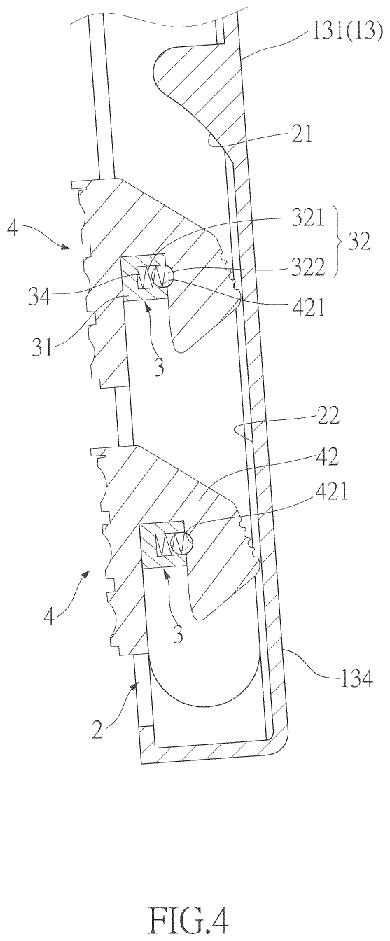

Referring to FIGS. 1 to 5, the crimping tool of the present invention comprises a tool body (1) including a clamping section (11) and a handle section (13). The clamping section (11) and the handle section (13) are pivotably connected to each other at a pivot section (12) so as to crimp terminals of different specifications and sizes. The handle section (13) has multiple accommodating slots (2), and each accommodating slot (2) of the handle section (13) has a corresponding slot opening. Each accommodating slot (2) includes at least one positioning unit (3). Each positioning unit (3) in the accommodating slots (2) includes a block (31). One of two ends of the block (31) that faces an inner bottom of the accommodating slot (2) has a positioning assembly (32). Each block (31) is polygonal, having multiple sides and angles. The multiple replacement clamping parts (4) are movably housed within the accommodating slots (2) and are respectively engaged with the blocks (31) of the at least one positioning unit (3). After being removed from the accommodating slots (2), each replacement clamping part (4) can be assembled to the clamping section (11).

The accommodating slots (2) located in the handle section (13) provide storage for various specifications of replacement clamping parts (4). Some of these clamping parts (4) can be installed in the accommodating slots (2), and others engaged with the clamping section (11). This allows users to replace different specifications of clamping parts (4) as needed on-site without the risk of losing them, as they are stored in the accommodating slots (2).

The present invention offers convenience and time efficiency, as users do not need to search for suitable dies separately. They can directly remove the replacement clamping parts (4) from the accommodating slots (2) and install them in the clamping section (11). The convenience lies in reducing the number of items to carry, users only need to carry a single tool body (1) equipped with multiple replacement clamping parts (4) for various tasks.

In terms of operation, the tool body (1) can be controlled through closing and opening actions. Closing is straightforward, as users simply close the handle section (13). However, opening requires pressing inward first due to the design and structure, generating a spring force during the process.

The invention leverages the special design of each block (31) with the positioning assembly (32) facing the inner bottom of the accommodating slots (2). Since the positioning assembly (32) apply force towards the bottom of the accommodating slots (2) and engage the replacement clamping parts (4), so that this prevents the clamping parts (4) from easily falling out when stored. Compared to traditional crimping tools that have a fixed number of apertures or require carrying additional replaceable dies, this invention significantly improves convenience and functionality.

As shown in FIGS. 1 to 5, the handle section (13) comprises two handles (131), and the two handles (131) pivot around the pivot section (12) to move closer or farther apart. The two handles (131) in the illustration are primarily composed of two plates (133) and an outer rubber sleeve (134), forming the accommodating slots (2). However, the design is not limited to the two plates (133) and outer rubber sleeve (134). In the present invention, the two plates (133) of each handle (131) are spaced apart, and the blocks (31) are set within this space. The outer rubber sleeves (134) cover the plates (133) to form the accommodating slots (2), and their positioning ensures that the openings of the accommodating slots (2) correspond to each other.

Each accommodating slot (2) is set on corresponding sides of the handles (131). The inner bottom of each accommodating slot (2) near the pivot section (12) forms an arc guide segment (21) protruding from the inner bottom, and the portion of the bottom surface near the pivot section (12) forms an accommodating segment (22). When a user wants to replace the replacement clamping parts (4), they can easily press against the protruding part of the replacement clamping parts (4) with their hand. The replacement clamping parts (4) housed in the accommodating slots (2) can be moved along the inner bottom towards the arc guide segment (21). Since the arc guide segment (21) curves towards the opening of the accommodating slots (2), the replacement clamping parts (4) are guided by the arc guide segment (21) and gradually reveal themselves at the slot opening of the accommodating slots (2). This allows the user to remove the replacement clamping parts (4) from the accommodating slots (2) and install them on the clamping section (11) or replace the ones already installed on the clamping section (11). The replaced clamping parts (4) can then be stored back into the accommodating slots (2).

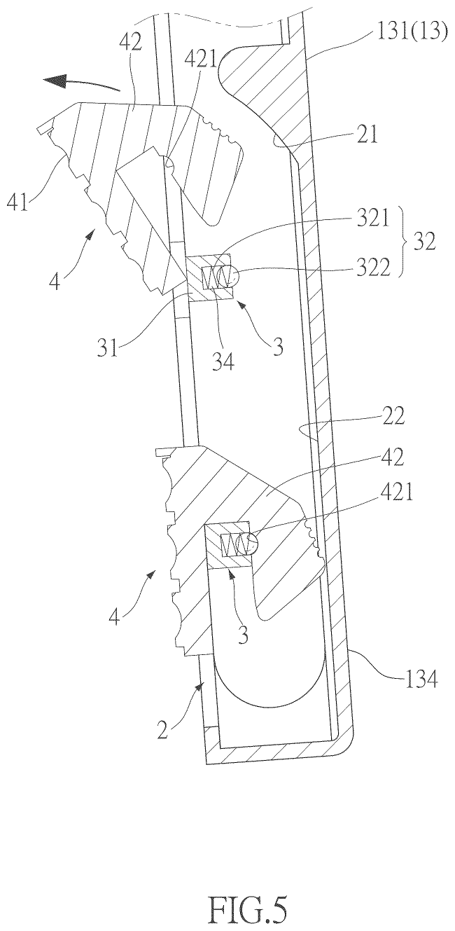

As shown in FIG. 5, for the replacement operation of the clamping parts (4), the at least one positioning unit (3) within each accommodating slot (2) is engaged with the replacement clamping parts (4) installed in the slots, ensuring that the clamping parts (4) are securely stored without affecting the work process. The positioning assembly (32) within the at least one positioning unit (3) consists of an elastic element (321) and a bead (322). Each block (31) is fixed inside each accommodating slot (2) and has a recessed installation slot (34) on one side. The beads (322) are housed in the installation slots (34) of the blocks (31). Each elastic element (321) is installed in the installation slot (34) of the block (31), with one end pressing against an inner bottom of the installation slot (34), and the other end pressing against the bead (322), causing part of the bead (322) to protrude from the opening of the accommodating slot (2). The diameter of the opening of the accommodating slot (2) is smaller than the diameter of the installation slot (34). The beads (322) are housed in the installation slots (34) and are positioning united by the openings of the accommodating slot (2), with part of the beads (322) protruding from the openings of the accommodating slot (2). When removing or storing the replacement clamping parts (4), the user only needs to apply slight pressure to move the clamping parts (4), disengaging them from the engagement with the at least one positioning unit (3).

Additionally, each replacement clamping part (4) includes a first part (41) and a second part (42). When installed in the accommodating slots (2), a portion of the first part (41) of each replacement clamping part (4) protrudes from the opening of the accommodating slot (2), allowing the user to apply pressure and move it. The second part (42) of each replacement clamping part (4) engages the at least one positioning unit (3) within the accommodating slots (2).

Furthermore, to facilitate engagement between the second part (42) of each replacement clamping part (4) and the bead (322) of the at least one positioning unit (3), each second part (42) has a dent (421). When the replacement clamping parts (4) are installed in the accommodating slots (2), a portion of the first part (41) protrudes from the opening of the accommodating slot (2). The second part (42) is engaged the block (31) of the at least one positioning unit (3), with the bead (322) engaged with the dent (421) of the second part (42). This prevents the replacement clamping parts (4) from falling out of the accommodating slots (2).

For replacement operations, slight pressure is sufficient to disengage the dent (421) of the second part (42) from the bead (322), allowing the clamping parts (4) to be removed from the accommodating slots (2) and installed on the clamping section (11) for crimping terminals.

While we have shown and described the embodiment in accordance with the present invention, it should be clear to those skilled in the art that further embodiments may be made without departing from the scope of the present invention.

What is claimed is:

1. A crimping tool comprising:
a tool body (1) including a clamping section (11) and a handle section (13), the clamping section (11) and the handle section (13) pivotably connected to each other at a pivot section (12), the handle section (13) having multiple accommodating slots (2), each accommodating slot (2) of the handle section (13) having a corresponding slot opening, each accommodating slot (2) including at least one positioning unit (3), each positioning unit (3) in the accommodating slots (2) including a block (31), one of two ends of the block (31) that faces an inner bottom of the accommodating slot (2) having a positioning assembly (32), and
multiple replacement clamping parts (4) movably located within each accommodating slot (2) and respectively engaged with each block (31) of the limiting assemblies (3), when the replacement clamping parts (4) are removed from the accommodating slots (2), each replacement clamping part (4) is assembled to the clamping section (11).

2. The crimping tool as defined in claim 1, wherein the handle section (13) comprises two handles (131), the two handles (131) pivot around the pivot section (12) to move closer or farther apart, each accommodating slot (2) is respectively defined on corresponding sides of the two handles (131), the inner bottom of each accommodating slot (2) forms an arc guide segment (21) which is located close to the pivot section (12), each arc guide segment (21) protrudes upwards from the inner bottom of the accommodating slot (2) towards the slot opening, the replacement clamping parts (4) in the accommodating slots (2) are moved towards the arc guide segment (21) along the inner bottom of the accommodating slot (2), the arc guide segments (21) guide the replacement clamping parts (4) to expose from the slot openings of the accommodating slots (2).

3. The crimping tool as defined in claim 1, wherein each positioning assembly (32) comprises an elastic component (321) and a bead (322), each block (31) has a recess (34) formed in one side thereof, each bead (322) is housed within the recess (34) of each block (31), each elastic component (321) is installed within the recess (34) of each block (31), and biased between an inner bottom of the recess (34) and the bead (322), such that each bead (322) partially protrudes from the recess (34), a diameter of the recess (34) is smaller than a width of the recess (34), each bead (322) is housed within each recess (34) and positioning united by an opening of each recess (34).

4. The crimping tool as defined in claim 1, wherein each replacement clamping part (4) comprises a first part (41) and a second part (42), when each replacement clamping part (4) is installed in each accommodating slot (2), the first part (41) of each replacement clamping part (4) partially protrudes from an opening of each accommodating slot (2), the second part (42) of each replacement clamping part (4) movably clamps the block (31) of the at least one positioning unit (3) within each accommodating slot (2).

5. The crimping tool as defined in claim 3, wherein each replacement clamping part (4) comprises a first part (41), a second part (42), and a dent (421) formed in the second part (42), when each replacement clamping part (4) is installed in each accommodating slot (2), the first part (41) of each replacement clamping part (4) partially protrudes from the opening of each accommodating slot (2), the second part (42) of each replacement clamping part (4) movably fits over the block (31) of the at least one positioning unit (3), each bead (322) partially protrudes from the opening of the recess (34) and is engaged with the dent (421) of each second part (42).

6. The crimping tool as defined in claim 2, wherein each of the two handles (131) comprises two plates (133) and an outer rubber sleeve (134), the two plates (133) of each handle (131) are spaced apart, each block (31) is located in a space between the two plates (133), each outer rubber sleeve (134) respectively covers the plates (133) to form each accommodating slot (2), and a covering position of each outer rubber sleeve (134) makes the openings of the accommodating slots (2) of the two handles (131) are located corresponding to each other.
